(19) United States
(12) Patent Application Publication
(10) Pub. No.: US 2022/0219115 A1
(43) Pub. Date: Jul. 14, 2022

(54) A SYSTEM AND METHOD FOR HANDLING A MULTIPLE PHASE HYDROCARBON FEED

(71) Applicant: Petroliam Nasional Berhad (PETRONAS), Kuala Lumpur (MY)

(72) Inventors: Abdullah Al Mubarak bin MD JALIL, Kuala Lumpur (MY); Khairul ROSTANI, Kuala Lumpur (MY); Nurzatil Aqmar OTHMAN, Kuala Lumpur (MY)

(21) Appl. No.: 17/614,113

(22) PCT Filed: May 28, 2020
(86) PCT No.: PCT/MY2020/050037

§ 371 Date: Nov. 24, 2021

(30) Foreign Application Priority Data
May 30, 2019 (MY) PI 2019003126

(51) Int. Cl. B01D 53/24; B01D 45/12; C10L 3/10; F25J 3/02

(52) U.S. Cl. CPC B01D 53/24; B01D 45/12; C10L 2290/541; F25J 3/0266; C10L 3/104

(57) ABSTRACT

A solid handling vessel comprising: a separation tank having an inlet for tangentially receiving an inflow of CO₂ enriched hydrocarbon feed stream; said separation tank to facilitate cyclonical flow of said feed stream; a heating assembly within the separation tank for maintaining the feed stream above a temperature for solidification of CO₂; a gas outlet arranged to vent gas from the separation tank; a collection tank located below, and in fluid communication with, the separation tank, said collection tank arranged to receive separated liquid and outflow said liquid from a liquid outlet.

### FIELD OF THE INVENTION

The invention relates to the removal of acidic gases such as CO₂, H₂S and other hydrocarbon heavy components from a hydrocarbon gas feed streams.

### BACKGROUND

The means by which acidic gases including CO₂ are removed from a hydrocarbon feed stream is dependent upon the concentration of CO₂ within the feed stream as well as anticipated flow rates.

One such method involves introducing a feed stream containing carbon dioxide and separating a gas stream using a nozzle adiabatic expander or cryogenic separation method including Joule Thomson valve and cryogenic distillation system.

A further means of separating CO₂ gas includes cyclonically separating solids and liquid phase from the feed stream whilst also cooling the feed stream so as to maintain the separated flow at a temperature below the acidic gas solid phase. Gas can then be removed directly from the separated gas flow with the solid phase passing to an additional collection tank.

It will be appreciated that the inflow into the separator may also be from a cyclonic separator and thus optimizing the separation process.

It will be appreciated that such a process, however, must balance the efficiency of removing a high proportion of the acidic gas from the original feed stream as well as managing the solid phase separated flow.

### SUMMARY OF INVENTION

In one aspect the invention provides a solid handling vessel comprising: a separation tank having an inlet for tangentially receiving an inflow of CO₂ enriched hydrocarbon feed stream in a mixed solid vapour liquid phase; said separation tank to facilitate cyclonical flow of said feed stream; a heating assembly within the separation tank for maintaining the feed stream above a temperature for solidification of CO₂; a gas outlet arranged to vent gas from the separation tank; a collection tank located below, and in fluid communication with, the separation tank, said collection tank arranged to receive separated liquid and outflow said liquid from a liquid outlet.

In a second aspect the invention provides a method of separating a gas component from a CO₂ enriched hydrocarbon feed stream, the method comprising the steps of: tangentially introducing said feed stream into a separation tank; cyclonically flowing of said feed stream so as to separate a portion of CO₂ gas; venting said CO₂ gas from a gas outlet; heating a separated liquid within the separation tank above a temperature for solidification of CO₂; flowing said separated liquid from the separation tank to a collection tank, and; outflowing said liquid from a liquid outlet.

Accordingly, by ensuring the temperature of the separated liquid phase does not fall below the temperature for solid CO₂ the flow rate, and consequently, the efficiency of the separation process is maintained

### BRIEF DESCRIPTION OF DRAWINGS

It will be convenient to further describe the present invention with respect to the accompanying drawings that illustrate possible arrangements of the invention. Other arrangements of the invention are possible and consequently, the particularity of the accompanying drawings is not to be understood as superseding the generality of the preceding description of the invention.

FIG. 1 is a cross-sectional top section view of a solid handling vessel according to one aspect of the present invention, and;

FIG. 2 is a cross-sectional longitudinal view of a solid handling vessel according to a further embodiment of the present invention;

### DETAILED DESCRIPTION

The system according to the present invention may be part of a process system to reduce hydrocarbon loss or enhance CO₂ separation in hydrocarbon gas mixture. This may achieved through a method of controlling the temperature in a vessel so that the frozen CO₂ is melted but not gassified. This will yield pure CO₂ stream in liquid form (and possibly more than 95% CO₂—which may be especially advantageous for CO₂ injection). This invention can be paired with other cryogenic separation system such as Gas Twister (Nozzle adiabatic separator), Joule Thompson Valve, Cryogenic Distillation system especially that goes into solid region.

The present invention seeks to solve flow issues of the prior art by controlling phase change from the separation tank to the collection tank.

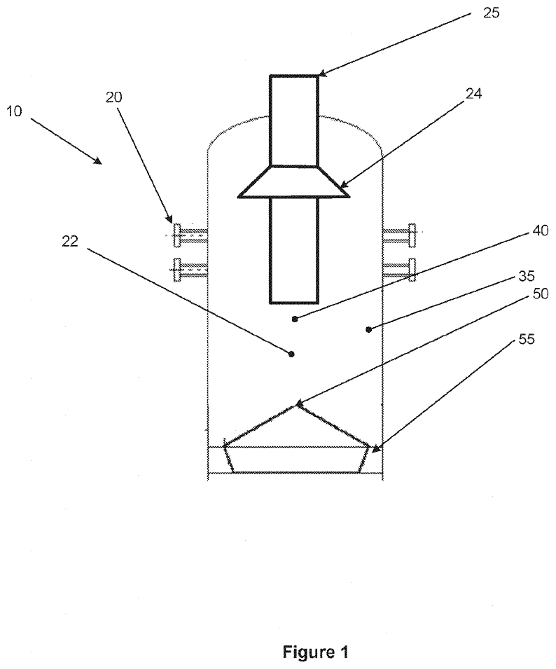

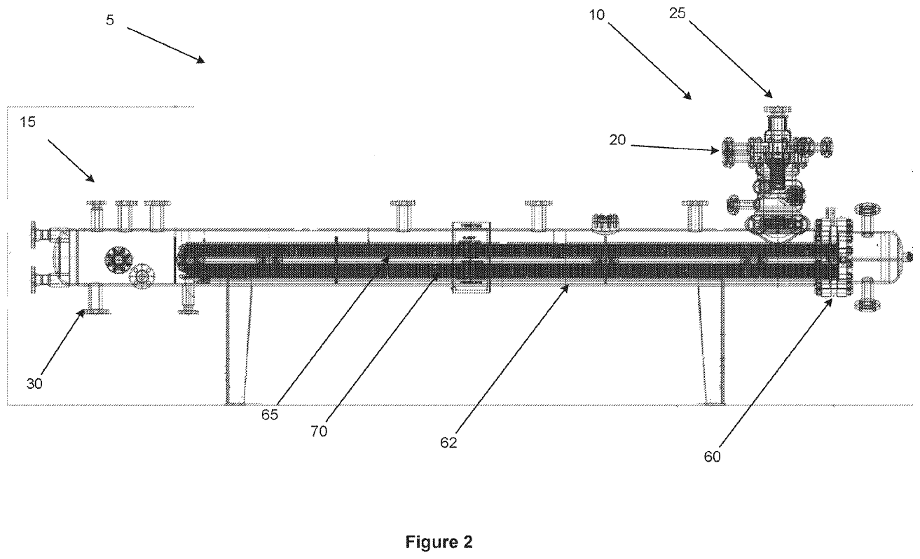

FIGS. 1 and 2 show the CO₂ solid handling vessel 5 according to the present invention. In this embodiment, the vessel 5 includes a top section 10 into which a 2-phase feed stream is introduced through an inlet 20, at design operating temperatures in the range of −100° C. to −40° C. The feed stream enters the chamber 22 tangentially so as to place the flow in cyclonic conditions with liquid moving in the outer peripheral area 35 and separated gas moving to the centre 40. The gas then exits from the gas outlet 25. The gas outlet may be in fluid communication with a further separation system, so as to further reduce the CO₂ concentration in the vented gas. In one embodiment, the vented gas from the gas outlet 25 may have a concentration of 20 to 30% CO₂ which is a 50-80% reduction from the inlet CO₂ concentration. A subsequent pass through a second separation stream may further reduce this to 2 to 15%.

The chamber 22 includes a heating assembly for maintaining the CO₂ above the freezing temperature so as to flow into the collection tank 60. It will be appreciated that the chamber 22 may include several heating assemblies so as to more uniformly heat the liquid.

The chamber 22 may further include a guide 24 to direct the gas flow upwards and fluid/solid flow downwards due to the cyclonic effect. A baffle 50 is provided intermediate the separation tank and the collection tank, proximate to the base of the chamber 22 such that in flowing downwards into the collection tank 60 the cyclonic flow of the liquid is hindered and permitted to flow through the peripheral vents 55 about the baffle 50 and substantially downward linear direction.

The bottom section 15 comprises the collection tank 60 having a liquid outlet 30 from which the liquid CO₂ flows.

The collection tank 60 includes a shell 62 containing a heat exchange assembly 70 to impart sufficient heat to prevent the liquid CO₂ turning solid. Should solid CO₂ form, the flow characteristics within the collection tank 60 and consequently outward flow from the outlet 30 would be hindered removing the efficiency of the process. To this end, in this embodiment the heat exchange assembly 70 includes tubes about which the liquid CO₂ flows within the shell 62 encapsulated by the collection tank 60. It will be appreciated that other heat exchange systems may be utilised to achieve a similar result of preventing substantial solidification of the CO₂. Within the tubes, a heat transfer medium flows, such that heat is imparted through the tube walls into the liquid CO₂.

In a further embodiment, the heat transfer medium may be a portion of the outflowing liquid CO₂. The outflowing CO₂, which is arranged to meet to design outflow temperature, is passed through the tubes. At this temperature, the outflowing CO₂ has sufficient heat so as to maintain the temperature of the CO₂ within the collection tank 60 above the temperature required for the liquid phase, and so preventing solids forming.

In this arrangement the liquid inlet 20 may be in fluid communication with an upstream source of the feed stream. For instance, cyclonic separators may provide a hydrocarbon stream containing the CO₂ to the vessel 5. Cyclonic separators will reduce the concentration of CO₂ within the hydrocarbon feed stream with the vessel 5 arranged to further reduce the concentration. In one embodiment, the liquid outlet stream may have a CO₂ concentration of 95% or above, leading to a hydrocarbon loss of less than 5%.

By way of example, the following conditions may be observed through the operation of a device according to the present invention. It will be noted that the following is not to be interpreted as limiting on the invention, and is provide as exemplary only.

For the conditions at Inlet 20:
Temperature: −60 to −80 C
CO2: 30-50%
Pressure: 15 to 30 bar

The system according to the present invention may be expected to provide the following outlet conditions.
Conditions at Liquid Outlet 30:
   Temperature: −50 to −60 C
   CO2: 95-99%
   Pressure: 15 to 30 bar
Conditions at Gas Outlet 25:
   Temperature: −50 to −60 C
   CO2: 20-30%
   Pressure: 15 to 30 bar

1. A solid handling vessel comprising:
a separation tank having an inlet for tangentially receiving an inflow of CO₂ enriched hydrocarbon feed stream;
the separation tank to facilitate cyclonical flow of the feed stream;
a heating assembly within the separation tank for maintaining the feed stream above a temperature for solidification of CO₂;
a gas outlet arranged to vent gas from the separation tank;
a collection tank located below, and in fluid communication with, the separation tank, the collection tank arranged to receive separated liquid and outflow the liquid from a liquid outlet.

2. The solid handling vessel according to claim 1, comprising a baffle plate intermediate the separation tank and collection tank for contacting the separated liquid so as to hinder the cyclonic flow.

3. The solid handling vessel according to claim 1, comprising a heat exchange assembly contained with the collection tank, the heat exchange assembly arranged to maintain a temperature of liquid within the collection tank above a temperature for solidification of CO₂.

4. The solid handling vessel according to claim 3, wherein the heat exchange assembly comprises a plurality of tubes within a shell, the shell arranged to receive the liquid within the collection tank and the tubes arranged to flow a heat transfer medium on an inside bore of the tubes.

5. The solid handling vessel according to claim 4, wherein the heat transfer medium comprises a portion of the liquid outflow from the collection tank.

6. A method of separating a gas component from a CO₂ enriched hydrocarbon feed stream, the method comprising:
tangentially introducing the feed stream into a separation tank;
cyclonically flowing the feed stream so as to separate a portion of CO₂ gas;
venting the CO₂ gas from a gas outlet;
heating a separated liquid within the separation tank above a temperature for solidification of CO₂;
flowing the separated liquid from the separation tank to a collection tank and
outflowing the liquid from a liquid outlet.

7. The method according to claim 6, comprising contacting the separated liquid within the separation tank with a baffle plate intermediate the separation tank and collection tank so as to hinder the cyclonic flow.

8. The method according to claim 6, comprising maintaining a temperature of the separated liquid within the collection tank above a temperature for solidification of CO₂ using a heat exchange assembly contained with the collection tank.

9. The method according to claim 8, comprising flowing a heat transfer medium in a bore of a plurality of tubes of the heat exchange assembly, the tubes located within a shell arranged to receive the separated liquid.

10. The method according to claim 9, wherein the heat transfer medium comprises a portion of the liquid outflow from the collection tank.
